(19) United States
(12) Patent Application Publication
(10) Pub. No.: US 2007/0182666 A1
(43) Pub. Date: Aug. 9, 2007

(54) CURTAIN DISPLAY UNIT FOR LIGHT EMITTING ELEMENTS

(75) Inventors: Jeremy Hochman, Austin, TX (US); Jeff Maddox, Austin, TX (US); Nils Thorjussen, Austin, TX (US); Christopher Varrin, Austin, TX (US); Matthew Ward, Santa Clara, CA (US)

Correspondence Address: OSHA LIANG L.L.P., 1221 MCKINNEY STREET, SUITE 2800, HOUSTON, TX, 77010, US

(73) Assignee: ELEMENT LABS, INC., Santa Clara, CA (US)

(21) Appl. No.: 11/670,035

(22) Filed: Feb. 1, 2007

Related U.S. Application Data
(60) Provisional application No. 60/764,160, filed on Feb. 1, 2006.
(60) Provisional application No. 60/818,582, filed on Jul. 5, 2006.

(51) Int. Cl. G09G 3/14

(52) U.S. Cl. 345/46

(57) ABSTRACT

A display unit, a display system, and a method of manufacturing thereof are disclosed. The display unit includes a first substrate and a second substrate attached to the first substrate to form a cavity between the substrates. A pixel is then disposed within the cavity and is configured to receive an electrical signal and power. The display system includes a plurality of display units having a first substrate with edges and a plurality of pixels disposed upon the first substrate. At least one edge of at least one of the display units is configured to removably attach to another edge of an adjacent display unit. The method includes providing a first and second substrate, and a pixel, attaching the first and second substrates together to form a cavity therebetween, and disposing a pixel within the cavity. The pixel is configured to receive an electrical signal and power.

### CROSS-REFERENCE TO RELATED APPLICATIONS

This application claims benefit of U.S. Provisional Application Ser. No. 60/764,160 filed on Feb. 1, 2006, entitled “Low Resolution LED Video Shower Curtain” in the names of Matthew Ward, Jeremy Hochman, Nils Thorjussen, Jeff Maddox, and Chris Varrin. This application also claims benefit of U.S. Provisional Application Ser. No. 60/818,582 filed on Jul. 5, 2006, entitled “Fastener for a Flexible Display System” in the names of Jeremy Hochman and Nils Thorjussen. The aforementioned applications are expressly incorporated by reference in their entirety.

### BACKGROUND OF INVENTION

1. Field of the Invention

Embodiments disclosed herein generally relate to display units and display systems. Specifically, selected embodiments relate to an improved display unit with pixels for use in various industries.

2. Background Art

Display units for entertainment, architectural, and advertising purposes have commonly been constructed using multiple pixels, such as light emitting diodes (LEDs) or incandescent lamps mounted onto flat panels. These pixels may be selectively turned on and off to create patterns, graphics, and video displays for both informational and visual purposes. It is well known in the art to construct these displays from tiles or large panels, each tile or panel containing several pixels. These tiles or panels may then be assembled in position for an entertainment show or event, or as an architectural or advertising display. Examples of such systems are disclosed in U.S. Pat. Nos. 6,737,983 and 6,677,918.

Increasingly, display units are being used on the exteriors of buildings for entertainment, architectural, or advertising purposes in a manner that does not fully integrate them into the style and physical envelope of the building. As the display unit market expands into new domains, the classic fixed structure of the display panel becomes a limitation. For example, Times Square in New York City and the Las Vegas Strip are two areas littered with such display units either contained within the wall of glass buildings or grafted onto the outside of buildings with little regard for the buildings' architecture. These types of display units face limits on transparency, weight, and how they are integrated with the architecture.

As this practice continues, it may be useful to incorporate the display units into the actual skin of the building. One technique of doing so is to combine the cladding system (e.g., a stainless steel or aluminum cladding system) with a display unit. The display unit could be a standard matrix type with the LED clusters mounted in holes or mounted on the exterior. U.S. Pat. No. 6,237,918 discloses such a system, effectively integrating the electronic and structural components of a display unit into the outer structure of a building. In this system, the LED beams forming a matrix of pixels are incorporated into a void in the glass wall of the building. However, this type of system has several limitations preventing full architectural usefulness of the display units. Such a system may be difficult to maintain because of its inaccessibility. Further, even when the system could be used to back light a graphic on the glass exterior, issues with line of sight would prevent the LED system from acting as a part of the graphic because the alignment of the two would shift as the viewer moves.

Further, many display units now use the word “curtain” to soften the public impression that LED displays are all composed of large metal boxes. However, several products that claim to be curtains do not function in such a way as the description would suggest. Generally, prior art curtains are rigid in structure and are not practical in use as a theatrical backdrop, such as a screen or fabric released from a box or sling and falls freely. However, through recent innovation, there are some designs and existing products that do function as a fabric or as a traditional curtain. An example of such a prior art curtain system is disclosed in U.S. Patent Application Publication No. 2005/0219171.

Referring to FIG. 1, an example of a portion 100 of a prior art curtain display unit is shown. Portion 100 of the display unit has an LED 102 secured with a washer 104. Washer 104 is attached to the reverse side of display unit portion 100, such as by adhesive, in which LED 102 is mounted within the central opening of washer 104. The entire display unit may be covered with several metal washers 104, which may make the display unit assume a degree of opacity not quite appropriate for a transparent material. Further, washers 104 may add extra weight to the display unit, making it bulky and unmanageable.

In a similar fashion to the prior art curtain display unit, there are several existing examples of display units with LEDs incorporated onto a net-like material. Examples of such systems are disclosed in U.S. Pat. Nos. 5,900,850 and 6,362,801. FIG. 2 shows an example of such prior art with panel 200. Panel 200 includes a net-like material 204 with LEDs 202 disposed upon net 204. These net-based products generally present maintenance concerns when used architecturally though, because garbage and birds may be trapped in the net.

Thus, there is a growing need for light weight, transparent, and flexible display units that would be useful even while not operating. Such display units would be portable systems that may be incorporated into any structure having regular or irregular surfaces, in addition to free-standing display systems.

### SUMMARY OF INVENTION

In one aspect, embodiments disclosed herein relate to a display unit including a first substrate, a second substrate, and a pixel. The second substrate is attached to the first substrate such that a cavity is formed between the first substrate and the second substrate, and the pixel is disposed within the cavity. Further, the pixel is configured to receive an electrical signal and power.

In another aspect, embodiments disclosed herein relate to a method for manufacturing a display unit. The method includes providing a first substrate, a second substrate, and a pixel. The method further includes attaching the second substrate to the first substrate such that a cavity is formed between the first substrate and the second substrate, and disposing a pixel within the cavity. The pixel is configured to receive an electrical signal and power.

In yet another aspect, embodiments disclosed herein relate to a display unit including a first substrate with edges and a plurality of pixels disposed on the first substrate. At least one of the edges of the first substrate of the display unit is configured to removably attach to an edge of at least one adjacent display unit, and the plurality of pixels are configured to receive an electrical signal and power.

Further, in yet another aspect, embodiments disclosed herein relate to a display system. The display system includes a plurality of display units, in which each display unit includes a first substrate with edges and a plurality of pixels disposed upon the first substrate and configured to receive an electrical signal and power. As least one edge of at least one of the display units is configured to removably attach to another edge of an adjacent display unit.

Other aspects and advantages of the invention will be apparent from the following description and the appended claims.

### BRIEF DESCRIPTION OF DRAWINGS

FIG. 1 shows a front view of a prior art LED display unit.

FIG. 2 shows a front view of another prior art LED display unit,

FIGS. 3A-3B show side views of display units in accordance with embodiments disclosed herein.

FIGS. 4A-4C show perspective views of display units in accordance with embodiments disclosed herein.

FIGS. 5A-5C show perspective views of display units in accordance with embodiments disclosed herein.

FIG. 6 shows a front view of a display unit in accordance with embodiments disclosed herein.

FIG. 7 shows a perspective view of a display system in accordance with embodiments disclosed herein.

FIG. 8 shows a perspective view of a display system including a plurality of display units in accordance with embodiments disclosed herein.

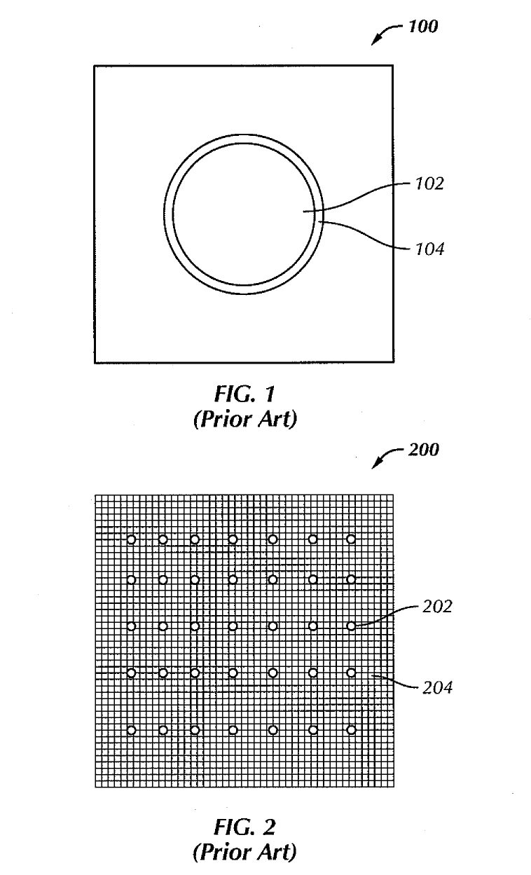

### DETAILED DESCRIPTION

In one aspect, embodiments disclosed herein relate to an improved display unit adapted to be transparent and blend in with its surroundings when not in use. In another aspect, embodiments disclosed herein relate to a display unit having cavities, in which a pixel is disposed in the cavities. Further, in another aspect, embodiments disclosed herein relate to a display unit configured to removably attach to adjacent display units.

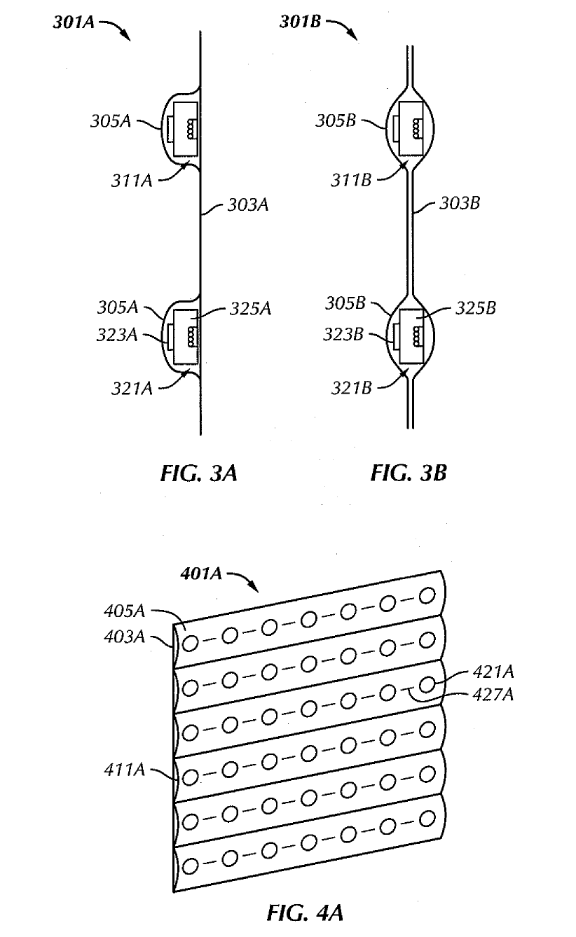

Referring to FIGS. 3A and 3B, side views of display units 301A and 301B in accordance with embodiments disclosed herein are shown. In FIG. 3A, display unit 301A includes a first substrate 303A and a second substrate 305A. Second substrate 305A is attached to first substrate 303A such that a cavity 311A is formed between substrates 303A and 305A. As shown, second substrate 305A is formed from a material of a smaller size than first substrate 303A and is attached thereto. The substrates may be attached by any method known in the art, such as by stitching, gluing, welding, or fusing the substrates together to form the cavity. For example, the specific material of the substrates may determine the method by which the substrates are attached together.

Disposed within cavity 311A of display unit 301A is a pixel 321A. In this embodiment, pixel 321A includes one or more light emitting elements 323A disposed upon and electrically connected to a printed circuit board (PCB) 325A. However, the light emitting elements may include, for example, light emitting diodes (LEDs), organic LEDs (OLEDs), polymer LEDs (PLEDs), incandescent lamps, or any other light emitting elements known in the art. Further, those having ordinary skill in the art will appreciate that the pixels, and their light emitting elements and printed circuit boards, may be of any size and shape. Preferably though, the pixels used within the display unit are as small as possible to maximize the transparency of the display unit.

In one embodiment, the pixels of the display unit may each include a plurality of LEDs such that light of a desired color may be emitted from each pixel. For example, a pixel may include at least one red LED, one green LED, and one blue LED (i.e., an LED cluster) such that the intensity of each LED may be varied to produce a desired color, as is known in the art. Further, the pixels may be of any size and shape (e.g., square, circular, etc.), in which the size and shape of pixels need not be uniform throughout the display unit. Furthermore, the pixels are configured to receive an electrical signal (e.g., a data signal, control signal, etc.) and power. Each pixel may also include a driver circuit that varies the intensities of the lighting emitting elements within the pixel.

Referring now to FIG. 3B, display unit 301B includes a first substrate 303B and a second substrate 305B, similar to FIG. 3A. However, substrates 303B and 305B, in this embodiment, are shown as materials of approximately equal sizes and are attached together to form cavities 311B. However, as shown in the comparison of FIGS. 3A and 3B, those having ordinary skill in the art will appreciate that the substrates may be of any size and shape, and the size and shape of the substrates need not be uniform throughout the display unit.

Further, as shown in FIGS. 3A and 3B, pixels 321A and 321B are arranged within cavities 311 A and 311B, respectively, to emit light in one direction from display units 301 and 301B. However, those having ordinary skill in the art will appreciate that the invention is not so limited, and the pixels may be arranged to emit light in both directions from the display unit. For example, in one embodiment, the pixels may be disposed and arranged in the cavities to alternate in directions such that half of the pixels emit light in one direction, and the other half of the pixels emit light in the opposing direction. In another embodiment, the substrates of the display unit may be attached together such that cavities are formed on both sides of the display unit. In such an embodiment, the display unit may be of a similar structure as the embodiment in FIG. 3A, only with an additional substrate, such as a third substrate, attached to the opposite side of the display unit from the second substrate, thereby forming cavities on both side of the display unit. Pixels may then be disposed in the cavities to emit light from both sides of the display unit. In yet another embodiment, the pixels disposed within the cavities may be capable of emitting light in both directions or sides of the display unit, such as by having LEDs on both sides of the pixel. Thus, the display unit of the present invention is not limited by the specific arrangement of the pixels within the cavities of the display unit.

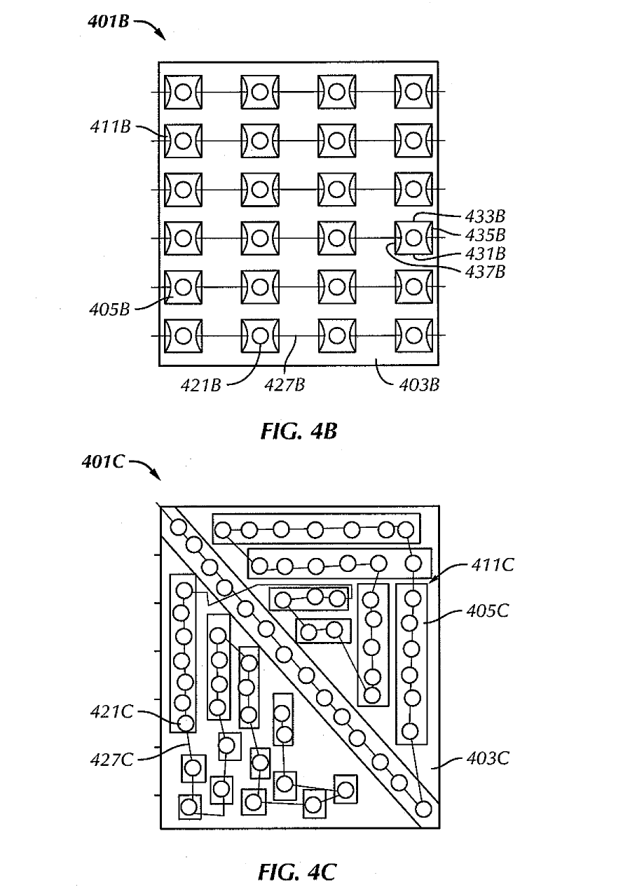

Referring to FIGS. 4A-4C, perspective views of display units 401A-401C in accordance with embodiments disclosed herein are shown. Display units 401A-401C each include a first substrate 403A-403C and a second substrate 405A-405C attached to one another such that a cavity 411A-411C is formed therebetween. In FIG. 4A, multiple pixels 421A are arranged in a pixel line with each pixel line disposed within a cavity 411 A. The pixel lines may be electrically connected with a cable 427A between pixels 421A to transfer an electrical signal and power from one pixel 421A to an adjacent pixel 421A. In FIG. 4B, display unit 401B includes multiple pixels 421B, in which each pixel 421B is disposed within a corresponding cavity 411B. Pixels 421B may also electrically connected with one another using a cable 427B. In FIG. 4C, some of pixels 421A are arranged in pixel lines and disposed in cavities 4111C, while other pixels 421A are disposed in their own corresponding cavities 411C. Similar to pixels 421A and 421B, pixels 421C may also be electrically connected with one another using cable 427C. Thus, as shown, the present invention may have any number of pixels disposed in the cavities of the display units. Further, the pixels may be arranged in a regular arrangement (e.g., matrix arrangement), as shown in FIGS. 4A and 4B, or the pixels may be arranged in an irregular arrangement, as shown in FIG. 4C.

When attaching the substrate materials of the display units to one another, the substrates may completely enclose the pixels so as to protect the pixels from the outside environment, or the substrates may only seal at portions of the edges so as to enable accessibility to the pixels. For example, in FIG. 4B, cavity 411B has a bottom edge 431B, a top edge 433B, a right edge 435B, and a left edge 437B. In one embodiment, all edges 431B-437B of cavity 411B may be completely attached between substrates 403B and 405B. In such an embodiment, cavity 411B may completely enclose pixel 421B disposed in cavity 411B to protect pixel 421B from the environment. However, in another embodiment, only bottom edge 431B and top edge 433B may be attached between substrates 403B and 405B. In this embodiment, cavity 411B may allow accessibility to pixel 421B disposed in cavity 4111B through edges 435B and 4377B for possible maintenance or modification. Regardless, those having ordinary skill in the art will appreciate that, as shown, the cavity may or may not completely enclose the pixel.

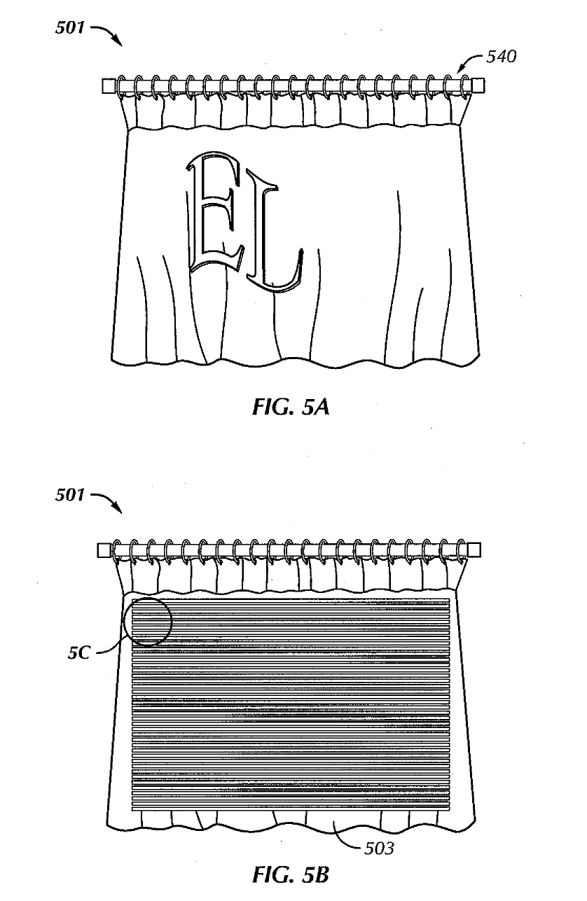

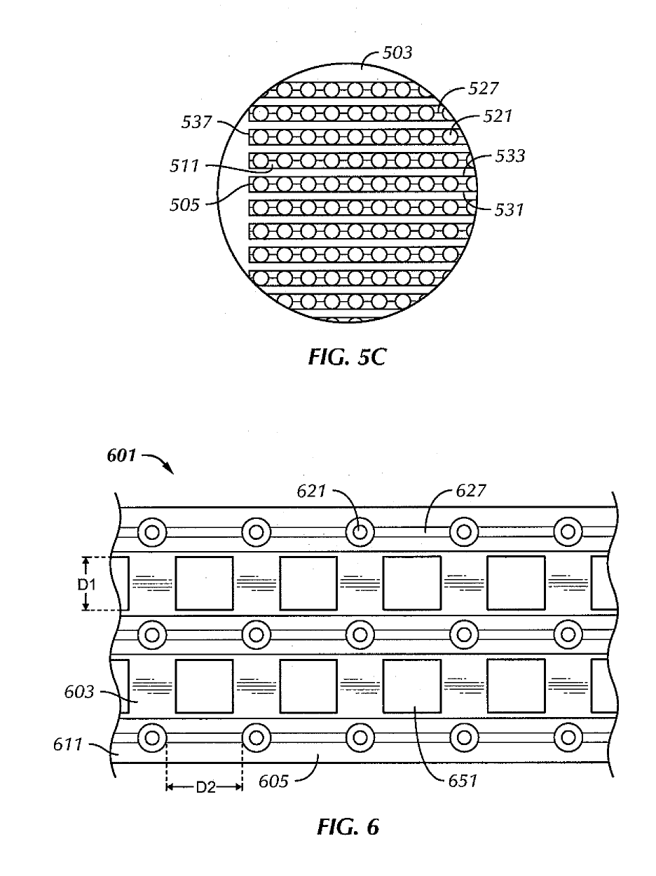

Referring now to FIGS. 5A-5C, multiple views of a display unit 501 in accordance with embodiments disclosed herein are shown. In FIG. 5A, display unit 501 is shown when in operation such that an image or video may be displayed.

Specifically, display unit 501 is configured to receive an electrical signal and power to display an image or video. The image or video is presented by selectively turning on and off, changing colors, and/or changing light intensity of pixels 521 within display unit 501. As shown, display unit 501 may be suspended by an attaching mechanism 540. Attaching mechanism 540 may include a rod with a plurality of rings to suspend and exhibit display unit 501, but those having ordinary skill in the art will appreciate that any other attaching mechanism known in the art may also be used, such as a tensioned cable system.

Referring now to FIGS. 5B and SC, a front view and a detail view of display unit 501 in accordance with embodiments disclosed herein are shown. In FIG. 5B, display unit 501, which includes a first substrate 503, is shown when not in operation. FIG. 5C provides a detail view of Figure SB. As shown, multiple portions of a second substrate 505 are attached to first substrate 503 such that multiple cavities 511 are formed between substrates 503 and 505. Multiple pixels 521 are then disposed within cavities 511. Specifically, in this embodiment, pixels 521 are arranged in pixel lines and are electrically connected with a cable 527, in which each of the pixel lines is disposed within each of cavities 511.

Substrates 503 and 505 of display unit 501 are formed and attached in such a way that cavities 511 are rectangular in shape, arranged horizontally on display unit 501, and extend substantially across the entire length of display unit 501. However, as discussed above, those having ordinary skill in the art will appreciate that the invention is not so limited, and the cavities and/or substrates of the present invention may be of any size and shape and any arrangement with the pixels disposed therein. Further, as shown in FIGS. 5A-5C, cavities 511 may include a bottom edge 531, a top edge 533, a right edge 537, and a left edge (not shown). However, only edges 531 and 533 may be attached between substrates 503 and 505 such that cavity 511 formed therebetween is similar to a sleeve for encasing pixels 521. However, as discussed above, those having ordinary skill in the art will appreciate that the invention is not so limited, and in another embodiment all of the edges of the cavities may be attached between the substrates such that the pixel is completely encased by the substrates in the cavities.

Preferably, the substrates of the display unit are manufactured from a flexible material, such as for use as a curtain and/or a theatrical backdrop. This flexible material used for the substrates may then include denim, polyester, vinyl, nylon, other plastic materials, or any other flexible material known in the art. However, those having ordinary skill in the art will appreciate that the invention is not so limited, and the substrates of the display unit may also be manufactured from a rigid material, such as for use as a billboard display. Further, those having ordinary skill in the art will appreciate that the substrates of the display unit may be manufactured from a material that is transparent, translucent, colored, opaque, diffusive, pre-printed, or any other decorative material known in the art. For example, in one embodiment, the display unit may be retractable and portable, may present an attractive appearance both when dormant and when illuminated, and may easily integrate with a wide range of chosen backgrounds or architecture. Furthermore, those having ordinary skill in the art will appreciate that in other embodiments, the substrates of the display unit may be manufactured from different materials, such as the first substrate is formed from a transparent material and the second substrate is formed from a diffusive material.

Referring to FIG. 6, a perspective view of a portion of display unit 601 in accordance with embodiments disclosed herein is shown. Display unit 601 includes a first substrate 603 and a second substrate 605 attached together to form a cavity 611 therebetween. Pixels 621 are electrically connected to each other and arranged in pixel lines with cable 627, with each pixel line disposed within a cavity 611. In this embodiment, display unit 601 may also include holes 651, such as holes 651 formed within in first substrate 603. Holes 651 may then enable display unit 601 to fall in a more predictable manner when in use. Further, holes 651 may be formed and arranged at predetermined distances D1 and D2 to allow holes 651 to maximize any desired effect. In the case that the display unit is used in an exterior application, the holes may be included to reduce wind resistance and to allow environmental elements (e.g., rain and snow) to pass through the display unit.

In other embodiments, the holes may be included in the cavities of the display unit, rather than only in the first substrate around the cavities (as shown in FIG. 6). In such an embodiment, the pixels and/or cables of the display unit may be encased in a protective housing, such as a sealed plastic housing, to protect the pixels and cables from any undesired environmental elements. Further, rather than only including holes, the display unit may additionally or alternatively include flaps and/or pockets to increase any desired effect such as to increase the wind resistance of the display unit. Thus, those having ordinary skill in the art will appreciate that the display unit may incorporate a number of alterations, such as holes and/or flaps, all within the scope of the present invention.

The display units of the present invention may also include support structures or support materials to increase the strength of the display unit. For example, in one embodiment, the display unit may include a rigid member, such as a rigid member attached to the substrates of the display unit, to reinforce the display unit. Rigid members may be used to prevent the display unit from fluttering or buffeting the wind, and may be used to stabilize the display unit while still allowing the display unit to remain generally flexible. The rigid member may include plastic, aluminum, wood, or any other material known in the art to increase the structural rigidity of the display unit. Further, in another embodiment, rather than rigid members, the display unit may include materials of high strength tensile properties. For example, the display unit may be laminated with carbon fiber to increase the tensile strength of the display unit. With this, the display unit may be folded, crumpled, pulled, and exposed to wind and water with decreased risk of damage to the display unit.

Referring now to FIG. 7, a perspective view of a display system 700 in accordance with embodiments disclosed herein is shown. Display system 700 includes a display unit 701 configured to electrically receive an electrical signal and power. Specifically, as shown, display unit 701 may include a power input 761 and a signal input 765 to provide an electrical signal and power. A power unit 763 may be used to provide power to display unit 701 through power input 761. Those having ordinary skill in the art will appreciate that the power unit may include any source of power, such as an electrical energy storage device (e.g., a battery) or photovoltaic components (e.g., solar panels). Furthermore, rather than be external to the display unit, the power unit may be included within the display unit. Furthermore still, those having ordinary skill in the art will appreciate that, rather than be directly connected to the display unit, the power input may be provided through the signal input.

Signal input 765 of display system 700 may be provided through a number of methods or sources known in the art. As shown in FIG. 7, a computer 769 (i.e., main processor) having a video card 771 may be used to provide a signal to signal input 765 of display unit 701. Computer 769 with video card 771 (i.e., a source) may be used to generate the signal (e.g., images, live or pre-recorded video) for system 700 to ultimately display the signal upon display unit 701. The signal output of computer 769 may be transmitted to a video processor 773 using, for example, a digital-visual-interface (DVI) output or a high-definition media interface (HDMI) output. Video processor 773 may then be used to convert the signal output from computer 769 into a signal input 765 for use within display unit 701. For example, the video processor may convert a DVI output from the computer into a HDMI signal input for the display unit. Alternatively, video processor 773 may be used to alter or encode the signal for signal input 765. For example, the video processor may encode or alter the signal from the computer into a format for use within the display unit. Those having ordinary skill in the art will appreciate that the signal from signal input of the display unit may then be used to control the desired brightness and desired color of the pixels of the display unit.

Referring still to FIG. 7, display unit 701 may also include a buffer 775, and pixels may include a driver circuit 729. Buffer 775 may be permanently or removably attached to display unit 701. However, those having ordinary skill in the art will appreciate that the buffer may not be attached to the display unit, or may not even be necessary for operation of the display unit. As shown though in this embodiment, signal input 765 of display unit 701 is connected to buffer 775. Buffer 775 may be used to control the flow of data from the signal of computer 769 to display unit 701 and pixels 721. Buffer 775 may then output the incoming signal from signal input 765 to a first pixel 721. Disposed upon and electrically connected to first pixel 721 may be a driver circuit 729. Driver circuit 729 may take or read the data from the signal corresponding to first pixel 721, and then output the signal to a next pixel 721 for the process to be repeated.

Those having ordinary skill in the art will appreciate that when the display unit is operated with a signal of its native resolution, the driver circuit may take or read the data and apply to the appropriate pixel of the display unit. With this, the data and signal from the output of the buffer may correspond directly with a pixel in the display unit. Otherwise, if the display unit does not operate from a signal of its native resolution, the appearance of each pixel may be affected by data from adjacent pixels, creating noise and distortion when the display system is in operation.

Generally, as shown, the signals between the electrical components of the display system and the display unit are transmitted by cables. However, those having ordinary skill in the art will appreciate that the present invention is not so limited, and the signal may be transmitted by an Ethernet cord, traces on a PCB, long and/or short range wireless communication, or any other transmission means known in the art. For example, in one embodiment, the display unit may receive the signal from the source to the signal input by using only wireless communication.

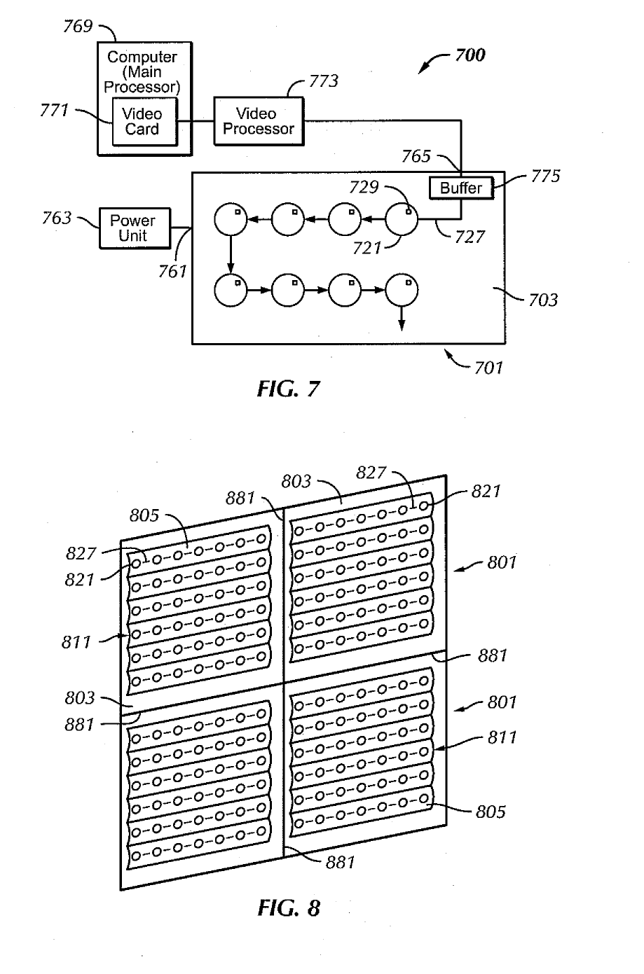

Referring now to FIG. 8, a perspective view of another display system 800 in accordance with embodiments disclosed herein is shown. Display system 800 includes multiple display units 801, each display unit 801 having a first substrate 803 and a second substrate 805. Substrate 803 and 805 of each display unit are attached to one another such that cavities 811 are formed therebetween. Pixels 821 may then be electrically connected to one another using cable 827 to form pixel lines, in which each pixel line is disposed within cavities 811 of display units 801.

As shown in FIG. 8, display units 801 of display system 800 are configured to removably attach to adjacent display units 801 Specifically, each edge 881 of first substrate 803 of each display unit 801 is configured to attach to another edge 881 of an adjacent display unit 801. Fasteners (not shown) may be used to removably attach these edges of the display units to one another. Fasteners, such as a zipper fastener, a magnetic fastener, or a snap fastener, may be disposed on the edges of the display units, in which the fasteners may be engaged to attach the edges of the adjacent display units to one another. However, those having ordinary skill in the art will appreciate that instead of fasteners, other methods known in the art may also be used to removably attach adjacent display units to one another, such as by hooks and eyelets, or by Velcro.

Embodiments of the present invention may provide for one or more of the following advantages. First, display units of the present invention having a flexible substrate may be architecturally more useful and aesthetically more pleasing than typical display units having a more rigid structure. For example, in one embodiment, flexible display units of the present invention may conform to irregular surfaces so as to provide less visual interference between the irregular surface and the display unit attached thereto. Further, display units of the present invention may include transparent material, in which the display units may then blend into the backgrounds of their environment more easily. Furthermore, display units of the present invention may be easily manufactured, and even more, be easily assembled into larger display systems. Furthermore still, display units of the present invention may provide for effective displays while in use, such as displaying pre-recorded or live video, and may be transparent when not in use.

While the invention has been described with respect to a limited number of embodiments, those having ordinary skill in the art, having benefit of this disclosure, will appreciate that other embodiments may be devised which do not depart from the scope of the present invention as disclosed herein. Accordingly, the scope of the invention should only be limited by the attached claims.

What is claimed is:

1. A display unit, comprising:
a first substrate;
a second substrate attached to the first substrate such that a cavity is formed between the first substrate and the second substrate; and
a pixel disposed within the cavity;
wherein the pixel is configured to receive an electrical signal and power.

2. The display unit of claim 1, wherein the cavity comprises a plurality of cavities.

3. The display unit of claim 2, wherein the pixel comprises a plurality of pixels.

4. The display unit of claim 3, wherein each of the plurality of pixels is disposed in each of the plurality of cavities.

5. The display unit of claim 3, wherein the plurality of pixels are arranged in pixel lines, wherein each of the pixel lines is disposed in each of the plurality of cavities.

6. The display unit of claim 5, wherein a cable electrically connects the plurality of pixels of each of the pixel lines together.

7. The display unit of claim 1, wherein at least one of the first substrate and the second substrate comprises at least one of a transparent material, a translucent material, a diffusive material, a colored material, an opaque material, and a pre-printed material.

8. The display unit of claim 1, wherein the first substrate and the second substrate comprise the same material.

9. The display unit of claim 2, wherein the first substrate and the second substrate comprise different materials.

10. The display unit of claim 1, wherein at least one of the first substrate and the second substrate comprises a non-rigid material.

11. The display unit of claim 10, further comprising a rigid member attached to at least one of the first substrate and the second substrate.

12. The display unit of claim 1, further comprising a plurality of holes disposed within at least one of the first substrate and the second substrate.

13. The display unit of claim 1, wherein the cavity comprises a hole and the pixel is encased in a protective housing.

14. The display unit of claim 1, wherein the pixel comprises an LED cluster having a red LED, a green LED, and a blue LED.

15. The display unit of claim 14, wherein the pixel further comprises a driver circuit configured to vary an intensity of light emitting from the red LED, the green LED, and the blue LED.

16. The unit of claim 1, further comprising a power input and a signal input.

17. A method for manufacturing a display unit, comprising:
providing a first substrate, a second substrate, and a pixel;
attaching the second substrate to the first substrate such that a cavity is formed between the first substrate and the second substrate; and
disposing a pixel within the cavity;
wherein the pixel is configured to receive an electrical signal and power.

18. The method of claim 17, wherein the cavity comprises a plurality of cavities and the pixel comprises a plurality of pixels.

19. The method of claim 18, wherein each of the plurality of pixels is disposed in each of the plurality of cavities.

20. The method of claim 19, wherein the plurality of pixels are arranged in pixel lines, wherein each of the pixel lines is disposed in each of the plurality of cavities.

21. A display unit, comprising:
a first substrate with edges;
a plurality of pixels disposed on the first substrate;
wherein at least one of the edges of the first substrate of the display unit is configured to removably attach to an edge of at least one adjacent display unit;
wherein the plurality of pixels are configured to receive an electrical signal and power.

22. The display unit of claim 21, wherein a fastener is used to removably attach at least one of the edges of the first substrate to an edge of at least one adjacent display unit.

23. The display unit of claim 22, wherein the fastener is one of a magnetic fastener and a zipper.

24. The display unit of claim 21, further comprising a second substrate attached to the first substrate such that a cavity is formed between the first substrate and the second substrate, wherein at least one of the plurality of pixels is disposed within the cavity.

25. A display system, comprising:
a plurality of display units, wherein each of the plurality of display units comprises:
a first substrate with edges; and
a plurality of pixels disposed upon the first substrate configured to receive an electrical signal and power;
wherein at least one edge of at least one of the display units is configured to removably attach to another edge of an adjacent display unit.

26. The display system of claim 25, wherein each of the plurality of display units further comprise a second substrate that attaches to the first substrate such that a cavity is formed between the first substrate and the second substrate, wherein at least one of the plurality of pixels is disposed within the cavity.
